(19) United States
(12) Patent Application Publication
(10) Pub. No.: US 2007/0013342 A1
(43) Pub. Date: Jan. 18, 2007

(54) Battery pack

(76) Inventors: Katsuhiro Suzuki, Sumoto-city (JP); Toru Nishikawa, Sumoto-city (JP)

Correspondence Address: WENDEROTH, LIND & PONACK, L.L.P., 2033 K STREET N. W., SUITE 800, WASHINGTON, DC, 20006-1021, US

(21) Appl. No.: 11/485,555

(22) Filed: Jul. 13, 2006

(30) Foreign Application Priority Data
Jul. 14, 2005 (JP) 205218/2005

(51) Int. Cl. H02J 7/00

(52) U.S. Cl. 320/112

(57) ABSTRACT

The battery pack is provided with batteries, a charging FET device to control battery charging, a discharging FET device to control battery discharging, and a control section to control the charging FET device and the discharging FET device. If one FET device is in the ON state and the other FET device is in the OFF state, and furthermore, current flow greater than or equal to a prescribed value is detected through the body (=parasitic) diode of the OFF state FET device for greater than or equal to a prescribed time interval, the control section switches the ON state FET device to the OFF state to prevent damage to the OFF state FET device.

### BACKGROUND OF THE INVENTION

1. Field of the Invention

This invention relates to a battery pack.

2. Description of the Related Art

A prior art battery pack is described in Japanese Patent Application Disclosure HEI 8-265985 (1996). A charging field effect transistor (FET) to protect batteries from over-charging, and a discharging FET to protect batteries for over-discharging are provided within this prior art battery pack. If battery voltage exceeds an over-charging cut-off voltage in this battery pack, the charging FET (Q1) is put in the OFF state to prevent battery (1) over-charging. Subsequently, it is determined whether the batteries are being discharged. For batteries in a state of discharge, the charging FET (Q1) is put in the ON state. This prevents current flow through the body (=parasitic) diode of the charging FET (Q1) in the OFF state, and prevents damage due to heating of that FET.

In addition, if battery voltage drops below an over-discharge cut-off voltage, the discharging FET (Q2) is put in the OFF state to prevent over-discharge of the batteries (1). Subsequently, it is determined whether the batteries are being charged. For batteries in a state of charging, the discharging FET (Q2) is put in the ON state. This prevents current flow through the body (=parasitic) diode of the discharging FET (Q2) in the OFF state, and prevents damage due to heating of that FET.

In electrical equipment housing this type of battery pack, such as a notebook personal computer, power is supplied to the battery pack from the electrical equipment during charging. To charge batteries inside the battery pack, a charging FET is provided inside the electrical equipment. Further, a discharging FET is provided inside the electrical equipment to discharge power from the battery pack and drive the electrical equipment during discharging.

In the prior art battery pack and electrical equipment described above, charging FETs and discharging FETs were provided in both the battery pack and electrical equipment. However, by eliminating the FETs inside the electrical equipment, and using only the charging FET and discharging FET inside the battery pack, power loss due to supply line resistance can be reduced as well as reducing the number of components.

In such case, the controller, which Is a microprocessor housed in the battery pack, monitors parameters such as battery voltage and issues ON and OFF signals to control the charging FET and discharging FET.

Here, depending on the electrical equipment's state of use, ON or OFF signals to control the charging FET and discharging FET are input to the battery pack from the electrical equipment. If, for example, the battery pack is in an over-charging or over-discharging condition, batteries are controlled not to charge or discharge even if there is an ON signal request from the electrical equipment. Control to put a FET in the ON state is performed when signals from the control section in the battery pack, and from the electrical equipment, both indicate an ON condition. This type of control was a known technique prior to the present invention.

### SUMMARY OF THE INVENTION

When one FET is in the ON state and the other FET is in the OFF state however, current flows through the body (=parasitic) diode of the OFF state FET. If high current flows through the OFF state FET, that device can be damaged. Further, even if a control signal is not issued from the electrical equipment with respect to a battery pack FET as described above, this problem can result in the same fashion in the case of control of the charging FET and discharging FET from within the battery pack.

The present invention was developed to solve these types of problems. In a battery pack that uses a charging FET device and a discharging FET device contained inside the battery pack, the present invention prevents the flow of high currents in an undesirable fashion through the body (=parasitic) diode of an OFF state device.

The present invention is a battery pack that supplies power to electrical equipment, is charged by the electrical equipment, and is characterized as follows. The present invention is provided with batteries, a charging FET device, a discharging FET device, a control section, and a control circuit inside the battery pack. Electrical equipment ON and OFF control signals are input to the battery pack from the electrical equipment to control each device. ON and OFF control signals are also issued from the control section inside the battery pack to control each device. The control circuit controls each device such that when both the electrical equipment control signal and the control signal from inside the battery pack indicate an ON condition for a device, that device is put in the ON state. When one device is in the ON state and the other device is in the OFF state, and current exceeding a prescribed value flows through the body (=parasitic) diode of the OFF state device for a time exceeding a prescribed time interval, the control section issues an OFF signal to the one ON state device to put it in the OFF state.

In addition, the present invention is a battery pack that supplies power to electrical equipment, is charged by the electrical equipment, and is characterized as follows. The present invention is provided with batteries, a charging FET device, a discharging FET device, a control section, and a control circuit inside the battery pack. Electrical equipment ON and OFF control signals are input to the battery pack from the electrical equipment to control each device. ON and OFF control signals are also issued from the control section inside the battery pack to control each device. The control circuit controls each device such that when both the electrical equipment control signal and the control signal from inside the battery pack indicate an ON condition for a device, that device is put in the ON state. When one device is in the ON state and the other device is in the OFF state, and current exceeding a prescribed value flows through the body (=parasitic) diode of the OFF state device for a time exceeding a prescribed time interval, the control section issues a signal that will result in putting the one ON state device in the OFF state.

Still further, the present invention is provided with batteries, a charging FET device, a discharging FET device, a control section, and a control circuit inside the battery pack. ON and OFF control signals are issued from the control section inside the battery pack to control each device. When one device is in the ON state and the other device is in the OFF state, and current exceeding a prescribed value flows through the body (=parasitic) diode of the OFF state device for a time exceeding a prescribed time interval, the control section issues an OFF signal to the one ON state device to put it in the OFF state.

In the battery pack described above, when one device is in the ON state and the other device is in the OFF state, and current exceeding a prescribed value flows through the body (=parasitic) diode of the OFF state device for a time exceeding a prescribed time interval, the control section can issue an OFF signal to the one ON state device to put it in the OFF state. Therefore, current flow can be stopped, and damage can be prevented to the OFF state device due to current flow through its body (=parasitic) diode

Further, when current exceeding a prescribed value flows for a time exceeding a prescribed time interval, the control section issues a signal to put the ON device in the OFF state. On the electrical equipment-side, a signal to put the ON device in the OFF state is issued to the battery pack based on the control section signal to put the ON device in the OFF state. The ON device can thereby be put in the OFF state from the electrical equipment-side. The above and further objects and features of the invention will more fully be apparent from the following detailed description with accompanying drawings.

### BRIEF DESCRIPTION OF THE DRAWINGS

FIG. 1 is a block diagram of a circuit of a battery pack of the present invention.

FIG. 2 is a flowchart showing the operational flow for an embodiment of the present invention.

### DETAILED DESCRIPTION OF THE PREFERRED EMBODIMENTS

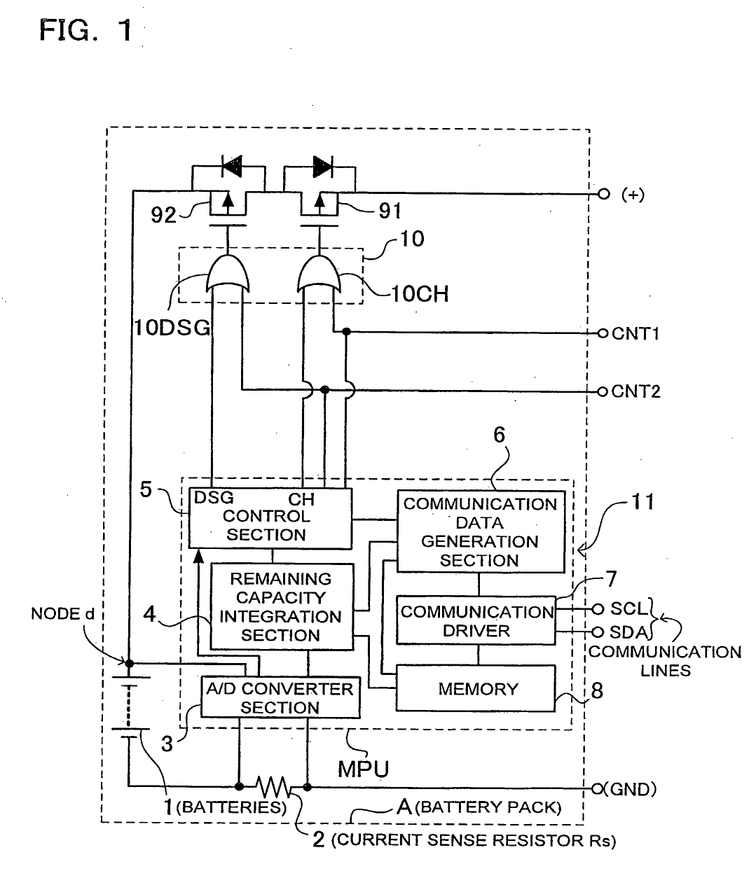

An embodiment of the present invention is described in detail with reference to the figures. As shown in FIG. 1, the battery pack A of this embodiment is provided with rechargeable batteries 1 such as lithium ion rechargeable batteries, a current sense resistor 2 (equivalent to a current detection section) to detect current during battery 1 charging and discharging, and a microprocessor unit (MPU) to monitor and control battery 1 charging and discharging. When the battery pack A is installed in electrical equipment, which is a personal computer (PC), battery 1 output is supplied to the PC through a positive (+) terminal and ground (GND) terminal. Communication with the PC is conducted via communication lines SCL, SDA. Meanwhile, charging power is supplied from the PC acting as a battery charger according to constant current charging and constant voltage charging, which limit maximum current and maximum voltage respectively.

The MPU is provided with an AID converter section 3 to convert analog battery voltage at measurement node d and analog voltage across the current sense resistor 2 to digital format and to actual voltage [mV] and actual current [mA] values, a remaining capacity integration section 4 to integrate charging and discharging current and compute remaining battery capacity, and a control section 5 to detect battery 1 full-charge and to control charging and discharging when abnormal current or voltage is detected, or when abnormal temperature is detected by a separately installed temperature-sensing element (not illustrated).

To cut-off charging current or discharging current, the control section 5 issues ON and OFF signals to a charging FET device 91 and a discharging FET device 92, which are p-channel FET devices.

To control the charging FET device 91 OFF when battery 1 voltage becomes greater than or equal to an over-charging voltage (for example, 4.2V), the control section 5 issues an OFF signal from the port CH (since the charging FET device 91 is a p-channel FET, an OFF signal voltage is a HIGH level signal applied to the gate). Similarly, to control the discharging FET device 92 OFF when battery 1 voltage becomes less than or equal to an over-discharging voltage (for example, 2.7V), the control section 5 issues an OFF signal from the port DCH (since the charging FET device 91 is a p-channel FET, an OFF signal voltage is a HIGH level signal applied to the gate). As mentioned, since signals are applied to the gates of p-channel FET devices 91, 92, OFF signals are HIGH level signals and ON signals are LOW level signals.

In addition, the PC outputs ON and OFF signals to the battery pack A via battery pack ports CNT1 and CNT2 to control the charging FET device 91 and discharging FET device 92 ON and OFF depending on PC operating conditions. These ON and OFF signals are input to the control section 5 as well as to a control circuit 10 described below. These ON and OFF signals from the PC-side are recognized and arbitrated by the control section 5.

A control circuit 10 is provided inside the battery pack A. The control circuit 10 provides ON and OFF signals to the gates of the charging FET device 91 and the discharging FET device 92 based on ON and OFF signals from the control section 5 CH and DSG ports and from the CNT1 and CNT2 ports. The control circuit 10 comprises OR logic circuits 10CH and 10DSG. Specifically, when signals at the control section 5 CH port and the CNT1 port are both ON signals (LOW level signals), control circuit 10CH outputs an ON signal (LOW level signal) to the gate of the charging FET device 91 to put the charging FET device 91 in the ON state. Consequently, the control circuit 10CH can be an OR logic circuit that outputs a LOW signal when LOW levels are input from the CH port and the CNT1 port.

Similarly, when signals at the control section 5 DSG port and the CNT2 port are both ON signals (LOW level signals), control circuit 10DSG outputs an ON signal (LOW level signal) to the gate of the discharging FET device 92 to put the discharging FET device 92 in the ON state. Consequently, the control circuit 10DSG can be an OR logic circuit that outputs a LOW signal when LOW levels are input from the DSG port and the CNT2 port.

If the FET devices are n-channel FET devices, the control circuit 10 can comprise AND logic circuits to provide HIGH signals to the n-channel, gates to turn on the FET devices.

In the present embodiment, the charging FET device 91 and discharging FET device 92 can be controlled ON with provision of a control section 5 and control circuit 10 having the functionality described above. For example, when the PC is powered normally by the battery pack A or the battery pack A is charged normally by the PC, ON signals are issued at CNT1, CNT2 and from control section 5 CH, DSG ports putting the charging FET device 91 and discharging FET device 92 in the ON state via outputs from the control circuit 10. As a result, the batteries 1 are discharged or charged.

In an over-charging situation, an OFF signal is issued from the control section 5 CH port. Even if an ON signal is issued at CNT1 from the PC for charging, etc., charging is suspended because an OFF signal is issued from the control circuit 10 to the charging FET device 91. At this point, if CNT2 is an ON signal due to PC discharging, etc., the discharging FET device 92 can be in the ON state because DSG is an ON signal. In this case, discharge can occur via the body (=parasitic) diode of the OFF state charging FET device 91.

Similarly, in an over-discharging situation, an OFF signal is issued from the control section 5 DSG port. Even if an ON signal is issued at CNT2 from the PC for discharging, etc., discharging is suspended because an OFF signal is issued from the control circuit 10 to the discharging FET device 92. At this point, if CNT1 is an ON signal due to PC charging, etc., the charging FET device 91 can be in the ON state because CH is an ON signal. In this case, charging can occur via the body (=parasitic) diode of the OFF state discharging FET device 92.

Further, signals to put one FET device in the ON state and the other FET device in the OFF state are issued at CNT1 and CNT2 in accordance with PC requirements. Here, if signals are issued from the control section 5 CH, DSG ports to put one FET device in the ON state and the other FET device in the ON or OFF state, one FET device will be put in the ON state and the other FET device will be put in the OFF state by control circuit 10 outputs. In this situation, current will flow through the body (=parasitic) diode of the OFF state FET device. In the present embodiment, if current greater than or equal to a prescribed current flows through the current detection section 2 for greater than or equal to a prescribed time interval (the need for FET protection is detected), the control section 5 outputs an OFF signal to control the ON FET device. Consequently, the control circuit 10 puts the ON FET device in the OFF state. Therefore, since charging or discharging current flow can be completely stopped, undesirable current flow through the body (=parasitic) diode of the OFF FET device can be prevented, and that FET device can be protected from damage.

In this fashion, when the need for FET protection is detected, control of the ON FET device by the control section 5 results in an OFF signal output from the control circuit 10 to put the ON FET device in the OFF state. However, the control section 5 may instead issue a signal to the PC to put the ON state FET device in the OFF state. In this case, control from the PC ultimately puts the ON state FET device in the OFF state. Here, control from the PC can result in OFF signals issued at the CNT1, CNT2 ports to control the FET devices and put the ON state device in the OFF state.

In the present embodiment, signals are issued from the PC to control FET devices inside the battery pack A. However, the CNT1, CNT2 ports and the control circuit 10 may be eliminated, and the charging FET device and discharging FET device may instead be controlled from within the battery pack A. In this case, ON and OFF signals from the control section 5 CH, DSG ports are directly supplied to the gates of the charging FET device 91 and discharging FET device 92. In the same fashion for this situation, if current greater than or equal to a prescribed current flows through the current detection section 2 for greater than or equal to a prescribed time interval (the need for FET protection is detected), the control section 5 outputs an OFF signal to put the ON FET device in the OFF state. By this action, since charging or discharging current flow can be completely stopped, undesirable current flow through the body (=parasitic) diode of the OFF FET device can be prevented, and that FET device can be protected from damage.

Meanwhile, in the remaining capacity integration section 4 of the MPU, charging and discharging current converted by the A/D converter section 3 is multiplied times the measurement sampling-time period (for example, 250 msec), and those resulting values are integrated. During discharging, integrated values are subtracted from full-charge, and during charging, integrated values are added to the remaining capacity at the start of charging. By these types of computations, remaining capacity of the batteries 1 is determined.

The control section 5 detects full charge from battery voltage and charging current converted by the A/D converter section 3, and outputs full charge information indicating remaining capacity at 100%. (For current or voltage restrained by constant current charging or constant voltage charging, full charge is determined by voltage at or above a set value or by current at or below a set value respectively.)

A communication data generation section 6 is provided to construct data signals that can be received by the electrical equipment, which is a PC (personal computer), or battery charger (that can be housed in the PC), etc., and that contain various battery information such as battery voltage, remaining capacity, and charging and discharging current values. A communication driver section 7 is provided to execute actual communication with the PC or battery charger. Memory 8 is provided to store various parameters for computing remaining capacity and to store various data, The communication driver section 7 receives requests from the electrical equipment for transmission of various battery pack information, and data signals generated by the communication data generation section 6 are sent to the electrical equipment from the communication driver section 7. The communication data generation section 6, communication driver section 7, and memory 8 make up the communication section 11 that communicates with the electrical equipment.

The remaining capacity integration section 4 is also provided with the following functionality. If a rechargeable battery such as a lithium ion rechargeable battery is repeatedly charged at voltages near the full-charge voltage, the battery itself can degrade faster, or frequent operation of safety mechanisms inside the battery cell, such as an over-charging protection circuit or protection device, can result in negative effects to reduce the lifetime (cycles of operation) of those mechanisms. To avoid these types of problems in the present embodiment, the remaining capacity integration section 4 forbids charging until capacity has dropped to a prescribed level (for example, 95% or below), or the corresponding voltage has dropped to a prescribed level (for example, 4V/cell). Information directing this action is output to the PC or battery charger via the communication data generation section 6.

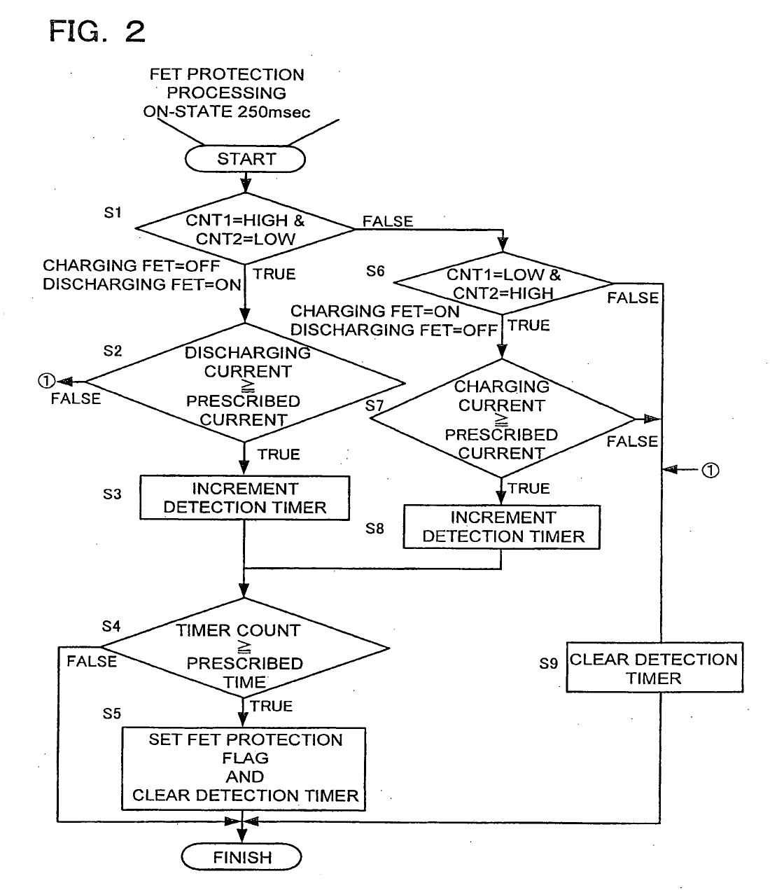

In this embodiment of the present invention, FET damage is prevented by control according to the following steps shown in FIG. 2. In the present embodiment, when ON signals are issued from the control section 5 CH, DSG ports, the flow shown in FIG. 2 is repeated with a prescribed period (for example, 250 msec) to repeatedly protect the FET devices. When only one of the CNT1, CNT2 ports outputs a signal to turn OFF a FET device, and current flow greater than or equal to a prescribed current for greater than or equal to a prescribed time interval is detected (the need for FET protection is detected), the control section 5 issues an OFF signal to the ON FET device to put both FET devices in the OFF state.

In step S1, signals requested from the PC are input to the control section 5 via the CNT1, CNT2 ports to determine if the request is for one FET device in the ON state and the other FET device in the OFF state. As a concrete example, we assume CNT1 is a HIGH (OFF) signal and CNT2 is a LOW (ON) signal in step S1. Then, if CNT1 is a HIGH (OFF) signal and CNT2 is a LOW (ON) signal in step S1, the charging FET device 91 is in the OFF state and the discharging FET device 92 is in the ON state.

If step S1 is true, it is determined if discharge current is greater than or equal to a prescribed (threshold) value (for example, 100 mA) in step S2. If current is greater than or equal to the prescribed value, the detection timer is incremented to start timing in step S3. When the timer has already been started in a previous period, timer count is continued. In step S4, if the timer has counted for greater than or equal to a prescribed time interval, a FET protection flag is set in step S5 indicating an abnormal condition has been found. Here, the control section 5 issues an OFF signal to the ON state FET device, the control circuit 10 outputs OFF signals, and ON state FET is put in the OFF state. In addition, the detection timer count is cleared. In step S4, if the timer has not counted for greater than or equal to the prescribed time interval, flow is returned to step S1 since the flow of FIG. 2 is repeated with a prescribed period.

In step S1, if CNT1 is not a HIGH (OFF) signal or CNT2 is not a LOW (ON) signal, it is determined if CNT1 is a LOW (ON) signal and CNT2 is a HIGH (OFF) signal in step S6. If CNT1 is a LOW (ON) signal and CNT2 is a HIGH (OFF) signal in step S6, the charging FET device 91 is in the ON state and the discharging FET device 92 is in the OFF state.

If step S6 is true, it is determined if charging current is greater than or equal to a prescribed (threshold) value (for example, 100 mA) in step S7. If current is greater than or equal to the prescribed value, the detection timer is incremented to start timing in step S8. When the timer has already been started in a previous period, timer count is continued. Subsequently, flow moves to step S4 described above.

If step S6 is false (both FET devices are either ON or OFF), the detection timer count is cleared in step S9.

In addition, in step S2 (and in step S7), a false outcome (indicating current below the prescribed value) results in a jump to step S9 where the detection timer count is cleared.

Here, the prescribed time interval for the detection timer is set to a time period that will not cause FET device failure with a FET body (=parasitic) diode current flow at the highest magnitude of either the maximum conceivable discharging current or the maximum conceivable charging current. Further, the prescribed time interval is set to a time period that will not blow a series-connected temperature fuse inserted in the current path and in thermal contact with the FET device. In the present embodiment, the prescribed time interval is set to approximately 1 sec.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within the metes and bounds of the claims or equivalence of such metes and bounds thereof are therefore intended to be embraced by the claims. This application is based on Application No. 2005-205,218 filed in Japan on Jul. 14, 2005, the content of which is incorporated hereinto be reference.

What is claimed is:

1. A battery pack that supplies power to electrical equipment and is charged by the electrical equipment comprising:
a battery,
a charging FET device to control charging of the battery,
a discharging FET device to control discharging of the battery, and
a control section to control the charging FET device and the discharging FET device;
wherein if one FET device is in the ON state and the other FET device is in the OFF state, and furthermore, current flow greater than or equal to a prescribed value is detected through the body diode of the OFF state FET device for greater than or equal to a prescribed time interval, the control section switches the ON state FET device to the OFF state.

2. A battery pack as recited in claim 1 wherein a timer is provided to detect when one FET device is in the ON state and the other FET device is in the OFF state, and furthermore, current flow greater than or equal to a prescribed value is detected through the body diode of the OFF state FET device for greater than or equal to a prescribed time interval.

3. A battery pack as recited in claim 1 wherein a control circuit connected to the gates of the charging FET device and discharging FET device is provided to control FET devices ON and OFF via internal battery pack control signals input from the control section and control signals input from electrical equipment connected with the battery pack; and the control circuit puts a FET device in the ON state when both the electrical equipment control signal and the internal battery pack control signal are ON signals.

4. A battery pack as recited in claim 1 wherein the charging FET device and the discharging FET device are p-channel FET devices, and the control circuit is an OR logic circuit.

5. A battery pack as recited in claim 1 wherein the charging FET device and the discharging FET device are n-channel FET devices, and the control circuit is an AND logic circuit.

6. A battery pack as recited in claim 1 wherein the battery is a lithium ion rechargeable battery.

7. A battery pack as recited in claim 1 wherein the control section detects battery voltage and controls the charging FET device OFF when battery voltage becomes greater than or equal to an over-charging voltage.

8. A battery pack as recited in claim 1 wherein the control section detects battery voltage and controls the discharging FET device OFF when battery voltage becomes less than or equal to an over-discharging voltage.

9. A battery pack as recited in claim 1 wherein electrical equipment is provided with connecting ports, and the control section arbitrates ON and OFF signals input from the electrical equipment via the ports.

10. A battery pack as recited in claim 3 wherein the electrical equipment is provided with connecting ports, ON and OFF signals input from the electrical equipment via the ports and internal battery pack control signals output from the control section are input to the control circuit, and the control circuit controls the charging FET device and discharging FET device ON and OFF.

11. A battery pack as recited in claim 1 wherein the control section controls the charging FET device and discharging FET device ON and OFF with signals input from electrical equipment connected with the battery pack.

12. A battery pack as recited in claim 1 wherein if one FET device is in the ON state and the other FET device is in the OFF state, and furthermore, current flow greater than or equal to a prescribed value is detected through the body diode of the OFF state FET device for greater than or equal to 1 sec, the control section switches the ON state FET device to the OFF state.
